(19) United States
(12) Patent Application Publication
(10) Pub. No.: US 2006/0069824 A1
(43) Pub. Date: Mar. 30, 2006

(54) Method of detecting printer interface and printer incompatibility and printing device employing the method

(76) Inventor: Leonard B. Hodder, Toronto (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/949,585

(22) Filed: Sep. 24, 2004

(51) Int. Cl. G06F 13/38

(52) U.S. Cl. 710/72

(57) ABSTRACT

A method of detecting printer interface and printer incompatibility comprises automatically sending a request for printer hardware and firmware information to the printer upon initialization of the printer interface in the printer. The printer hardware and firmware information received in response to the request is examined to determine if the printer interface is compatible with the printer. Output is generated when the printer interface is not compatible with the printer.

### FIELD OF THE INVENTION

The present invention relates generally to printing devices and in particular, to a method of detecting printer interface and printer incompatibility and to a printing device employing the method.

### BACKGROUND OF THE INVENTION

Stand-alone electronic cash registers including payment card readers and receipt printers have been used for years in stores, retail outlets and service outlets to facilitate the completion of cash, cheque, credit card or debit card transactions for the purchase of goods and/or services. With the advent of sophisticated and inexpensive computing equipment, input devices and secure communication networks, point-of-sale (POS) stations have become an increasingly popular alternative.

POS stations typically include a host device and a plurality of interchangeable peripherals connected to the host device. The host device and peripherals are easily integrated allowing the configuration of POS stations to be modified to meet changing needs. This has been another factor leading to their widespread acceptance. The host device is commonly in the form of a personal computer. The peripherals often include a keyboard, a display screen, a cash drawer, a printing device, a payment card reader and a barcode reader. In some cases, a touch-sensitive display screen is used instead of separate keyboard and display screen peripherals.

As is well known, the host device communicates with the peripherals and executes software to allow product and/or service transactions to be completed. When payment is effected using a debit or credit card, the host device establishes a connection to the appropriate financial institution over an information network so that approval for the transaction may be obtained. Upon completion of any transaction, the host device creates and transmits a print job to the printing device causing the printing device to generate a transaction receipt and a possibly signing receipt, if payment is made using a credit card.

In larger stores, retail outlets and service outlets, POS stations are typically linked via a local area network and communicate with a backend computing device that maintains a database for transaction, inventory, accounting, sales, tax, etc. information. Transaction data received by each of the POS stations is conveyed to the backend computing device for storage in the database allowing all transaction data to be stored in a common location. Collectively storing all transaction data in one common location allows retailers to track, account for and maintain inventory, collected taxes and pricing information. Also, by linking the POS stations, updates relating to sales on products and/or services, tax, etc. can be communicated to each POS station over the local area network avoiding the need to update the POS stations one at a time.

Printing devices commonly used in POS stations comprise a printer having a slot for receiving a separate printer interface that controls communications between the host device and the printer. The printer interface is primarily selected based on the communication protocol used by the host device thereby to ensure hardware compatibility between the host device and the printer. For example, hardware compatibility may be achieved by installing a serial, parallel, Ethernet or USB interface into the printer slot. As the printer interface can be readily changed, the printer is not limited for use with any particular communication protocol but rather can be used in many different communication protocol environments simply by replacing the printer interface. The printer interface may also be selected to enhance functionality of the printer such as by adding supplemental fonts or by emulating one or more other printer models.

The printer interface and the printer are typically preloaded with firmware although the printing device may receive updated printer firmware from the host device to replace or patch the existing printer firmware. Updated printer firmware received from the host device by the printer interface is in turn conveyed to the printer for storage therein.

The printer firmware typically includes a boot file, a main firmware file and one or more font files. The boot file is executed by the printer during initialization to place the printer into a ready operating state. The main firmware and font files are executed during normal operation of the printer to allow the printer to respond to print commands received from the host device via the printer interface so that appropriate transaction receipts can be printed. The font file typically contains glyph or shape data for each character in the font file character sets.

In many instances it is desired to upgrade the printing device to allow the printing device to print receipts in different formats and/or languages, to support additional functionality and/or to enhance printer performance. This requires the printer interface in some cases to be replaced. Depending on the nature of the printer firmware and/or the communications mode of the printer, an installed printer interface may not be compatible with the printer. For example, POS printers typically support a number of different communication modes, not all of which are compatible with individual printer interfaces. This of course can lead to problems in that if the installed printer interface is not compatible with the printer, the printing device will not operate properly, if at all. As a result, it is important to determine whether an installed printer interface is compatible with the printer.

Not surprising, a number of techniques have been considered to detect compatibility between electronic components. For example, U.S. Pat. No. 5,579,509 to Furtney et al. discloses an apparatus and method for verifying compatibility of system components wherein each of the system components stores a version identifier in a location accessible by other components. When components are required to interact with each other, each component reads the other's identifier and compares it to an internally stored compatibility record. Any component which detects an incompatibility signals an error.

U.S. Pat. No. 6,023,727 to Barrett et al. discloses a reprogrammable network communication device such as a network board that contains a stored programmable image and configuration information. Compatibility of a new program image with the network communication device is determined by comparing the new program image with the stored configuration information. When incompatibility is detected, a message is sent to an administrator.

U.S. Pat. No. 6,655,779 to Usui et al. discloses a method whereby an ink cartridge stores a production code which is referencable by a printer to which it is attached. The printer compares the production code with a list of production codes in order to determine compatibility. The printer displays information representing the incompatibility level so that the user can either update the printer driver or change the ink cartridge.

U.S. Patent Application Publication No. 2003/0014470 Iijima discloses a method of verifying version compatibility between units of electronic equipment. Control programs stored in controller units on a board containing an interface for a printer are compared with programs in a mechanism control unit of the printer in order to determine version compatibility. If the mechanism controller unit or a controller unit on the board is substituted, automatic version substitution occurs if a version incompatibility is detected.

U.S. Patent Application Publication No. 2003/0053810 to Jackelen et al. discloses a method of detecting incompatibility between print job attributes such as specified media characteristics and finishing operations, and printer resources. A printer is put into a mismatch state upon detection of incompatibility and a message is displayed on the printer's user interface that a given problem with incompatibility exists.

U.S. Patent Application Publication No. 2003/0234950 to Lay discloses a system which notifies a user when there is a mismatch between a printer and a printer driver on a host computer. A printer/driver compatibility list is referred to when the printer driver is activated upon initiation of a print command. If the printer identification information does not match up with any printer on the compatibility list, a notification module notifies the user of a mismatch between the printer and the printer driver. The notification is displayed on the screen of the host computer.

Although the above references describe methods of detecting compatibility between electronic components, improvements in printing device compatibility determination are desired.

It is therefore an object of the present invention to provide a novel method of detecting printer interface and printer incompatibility and to a printing device employing the method.

### SUMMARY OF THE INVENTION

Accordingly, in one aspect of the present invention there is provided a method of detecting printer interface and printer incompatibility. During the method, at least one query is sent from the printer interface to the printer requesting information concerning the printer. In response to the query, a determination is made as to whether the printer interface is compatible with the printer. If the printer interface is not compatible with the printer, a non-compatible printer interface condition is signaled.

The at least one query may comprise a request for printer hardware information from the printer. If the printer hardware information received from the printer indicates that the printer interface is not compatible with the printer hardware, the printer interface signals an incompatible printer condition.

The at least one query may comprise a request for printer firmware information from the printer. If the printer firmware information received from the printer indicates that the printer interface is not compatible with the printer firmware, the printer interface signals an incompatible firmware condition.

The at least one query may comprise a request for printer configuration information from the printer. If the printer configuration information received from the printer indicates that the printer interface is not compatible with the printer configuration, the printer interface signals an incompatible printer configuration condition.

In one embodiment, signaling of the non-compatible condition of the printer interface includes illuminating a light source and/or sounding a sound emitting device. The light source may be in the form of one or more light emitting diodes that are illuminated in a flashing pattern unique to the non-compatible condition of the printer interface.

Prior to sending of the at least one query, communications with the printer can be attempted to detect hardware compatibility between the printer interface and the printer. If the printer interface and the printer hardware are compatible, the at least one query is sent. Otherwise, sending of the at least one query is skipped and the non-compatible printer interface condition is signaled.

According to another aspect of the present invention there is provided a method of detecting printer interface and printer incompatibility. During the method, a request is automatically sent for printer hardware and firmware information to the printer upon initialization of the printer interface. The printer hardware and firmware information received in response to the request is examined to determine if the printer interface is compatible with the printer. Output is generated when the printer interface is not compatible with the printer.

According to yet another aspect of the present invention there is provided a printing device comprising a printer having a processing unit, memory storing printer firmware executed by the processing unit and a printer control mechanism responsive to the processing unit and printing information on a medium. A printer interface is coupled to the printer and includes a processing unit and memory storing a printer interface compatibility determination procedure. The printer interface compatibility determination procedure is automatically executed when the printer interface is initialized to determine whether the printer interface is compatible with the printer. The processing unit generates output when the printer interface is not compatible with the printer.

The printer interface compatibility determination method provides advantages in that upon initialization, the printer interface automatically checks to determine if it is compatible with the printer. If the printer interface is determined not to be compatible with the printer, the printer interface generates output identifying the nature of the incompatibility.

### BRIEF DESCRIPTION OF THE DRAWINGS

Embodiments will now be described more fully with reference to the accompanying drawings in which:

FIG. 1 is a schematic block diagram of a point-of-sale station including a printing device;

FIG. 2 is a schematic block diagram of the printing device of FIG. 1; and

FIG. 3 is a flowchart showing the general steps performed by the printing device during printer interface compatibility determination.

### DETAILED DESCRIPTION OF THE EMBODIMENTS

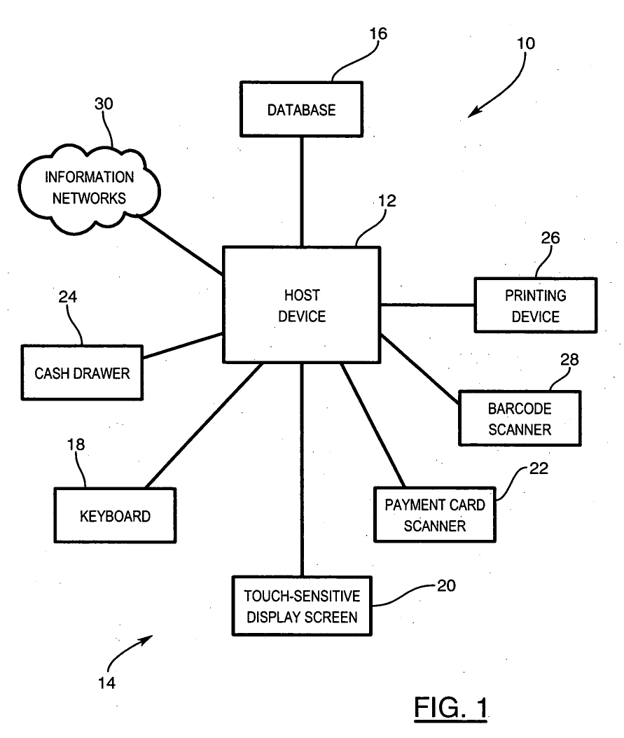

Turning now to FIG. 1, a point-of-sale (POS) station is shown and is generally identified by reference numeral 10. As can be seen, POS station 10 includes a microprocessor-based host device 12 in the form of a personal computer that communicates with a plurality of peripherals generally identified by reference numeral 14 and with a database 16 storing transaction, inventory, pricing, tax and accounting information. In this example, peripherals 14 include a keyboard 18, a touch-sensitive display screen 20, a payment card scanner 22, a cash drawer 24, a printing device 26 and a barcode scanner 28. Host device 12 also communicates with financial institutions (not shown) such as banks and credit card companies over one or more information networks generally identified by reference numeral 30.

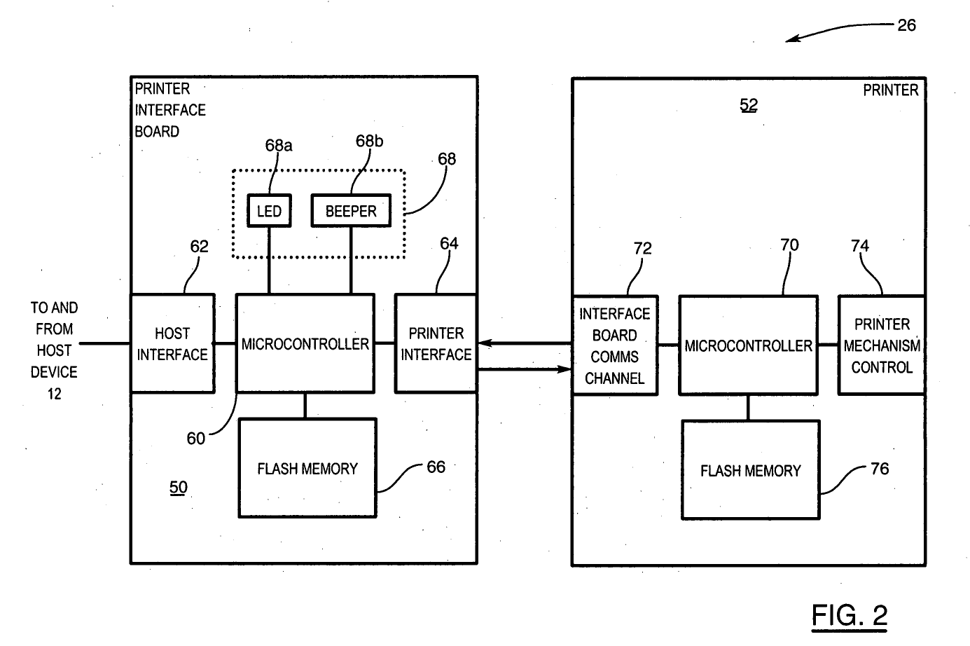

Printing device 26 is best illustrated in FIG. 2 and includes a printer interface 50 and a printer 52. Printer interface 50 comprises a microcontroller 60, a host interface board 62, a printer interface board 64, non-volatile flash memory 66 and incompatibility indicating circuitry 68. Incompatibility indicating circuitry 68 includes a visual indicator in the form of a light emitting diode (LED) and a sound emitting device 68b in the form of a beeper. Printer 52 comprises a microcontroller 70, a communications channel interface board 72, a printer control mechanism 74 and non-volatile flash memory 76. For example, the printer interface 50 may be of the type sold by EPSON under model No. UB-EML and the printer 52 may be of the type sold by EPSON under model No. TM-U200.

The non-volatile memory 66 stores printer interface firmware that is executed by the microcontroller 60 during initialization and operation of the printing device 26 to permit communications between the host device 12 and the printer 52 and optionally, to enhance operation of the printer by storing supplemental font files that allow the printer to print characters of different style and/or size and/or emulation files that allow the printer to emulate one or more other printer models.

The non-volatile memory 66 of the printer interface 50 also holds a list of the printers with which the printer interface is compatible, a list of main firmware version strings with which the printer interface 50 is compatible and a list of boot code version strings with which the printer interface 50 is compatible.

The non-volatile memory 76 stores printer firmware that is executed by the microcontroller 70 during initialization and operation of the printing device 26 to allow the printer 52 to respond to commands generated by the host device 12 and print appropriate receipts when a transaction is completed. In this particular embodiment, the printer firmware includes a boot file, a main firmware file and a font file. The firmware also includes printer hardware and firmware identification information to enable the printer interface 50 to determine the type of printer 52 and the status of the resident printer firmware. For example, the printer hardware and firmware identification information includes the version string of the main firmware file, the version string of the boot file, the version of the font file and the printer model identification number (ID). The printer model ID is a single data byte, the value of which is unique to the printer 52.

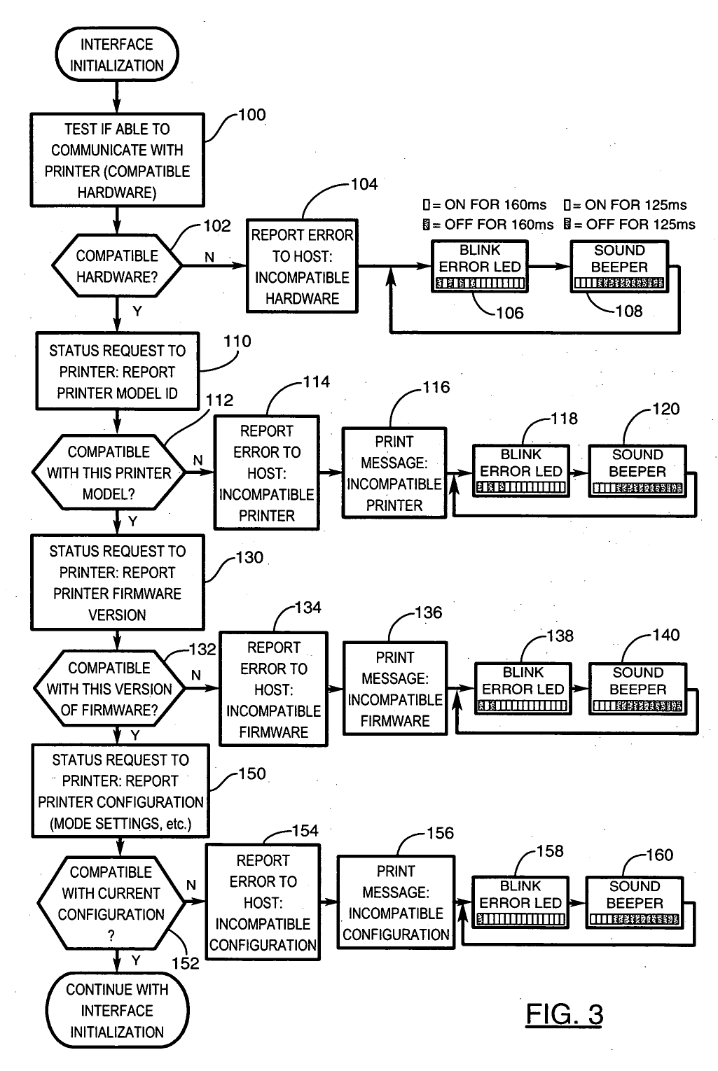

When a printer interface 50 is installed in the slot of the printer 52 and the printing interface is powered or the printing device 26 is reset, the printer interface 50 automatically initiates a printer interface compatibility determination procedure stored in the non-volatile memory 66 to determine if the printer interface 50 is compatible with the printer. FIG. 3 illustrates the steps performed during the printer interface compatibility determination procedure.

As can be seen, initially the microcontroller 60 attempts to initiate communications with the printer 52 to determine if the printer interface hardware is compatible with the printer (step 100). In particular, the printer interface 50 attempts to communicate with the printer 52 synchronously using a synchronous serial interface. If the printer interface is unable to communicate with the printer 52 in this manner, the printer interface 50 attempts to communicate with the printer 52 asynchronously. If the printer interface 50 is unable to communicate with the printer 52 in either manner, the printer interface is deemed to be hardware incompatible with the printer. Other hardware conditions may of course also exist that make the printer interface hardware incompatible with the printer. If the printer interface hardware is deemed to be not compatible with the printer (step 102), the microcontroller 60 sends a message to the host device 12 reporting the hardware incompatibility condition (step 104). The microcontroller 60 also flashes the light emitting diode in a fixed pattern unique to the non-compatible hardware condition and sounds the beeper 68b intermittently so that the non-compatible hardware condition can be readily detected (steps 106 and 108).

If the printer interface 50 is able to communicate with the printer either synchronously or asynchronously, and is otherwise hardware compatible with the printer 52, the microcontroller 60 sends a query to the printer 52 requesting the printer model ID of the printer 52 (step 110). The microcontroller 70 in response to this query retrieves the printer model ID stored in the non-volatile memory 76 and transmits the printer model ID to the printer interface 50. Upon receipt, the microcontroller 60 compares the received printer model number with the printer model number list stored in the non-volatile memory 66 to detect coincidence and hence, printer compatibility (step 112). If the result of the comparison is negative indicating that the printer interface 50 is not compatible with the model of the printer, the printer interface 50 sends a message to the host device 12 reporting the non-compatible printer condition (step 114). The printer interface 50 then conveys a command to the printer 52 causing the printer to print an “Incompatible Printer” message (step 116). The printer interface 50 also flashes the light emitting diode 68a in a fixed pattern unique to the non-compatible printer condition and sounds the beeper 68b intermittently so that the non-compatible printer condition can be readily detected (steps 118 and 120).

If the result of the comparison is positive at step 112, the microcontroller 60 sends another query to the printer 52 requesting the firmware file version string of the resident printer firmware (step 130). The microcontroller 70 in response to this query retrieves the firmware file version string from the resident printer firmware and transmits it to the printer interface 50. Upon receipt, the microcontroller 60 compares the received firmware file version string with the list stored in the non-volatile memory 66 to detect coincidence and hence, firmware compatibility (step 132). If the result of the comparison is negative indicating that the printer interface 50 is not compatible with printer firmware, the printer interface 50 sends a message to the host device 12 reporting the non-compatible firmware condition (step 134). The printer interface 50 then conveys a command to the printer 52 causing the printer to print an “Incompatible Firmware” message (step 136). The printer interface 50 also flashes the light emitting diode 68a in a fixed pattern unique to the non-compatible firmware condition and sounds the beeper 68b intermittently so that the non-compatible firmware condition can be readily detected (steps 138 and 140).

If the result of the comparison is positive at step 132, the microcontroller 60 sends yet another query to the printer 52 requesting the current printer configuration (step 150). The microcontroller 70 in response to this query sends a message to the printer interface 50 identifying its current DIP switch settings. Upon receipt, the microcontroller 60 examines the received DIP switch settings to determine if the printer configuration is compatible with the printer interface 50 (step 152). If the result of the comparison is negative indicating that the printer interface 50 is not compatible with the current printer configuration, the printer interface 50 sends a message to the host device 12 reporting the non-compatible printer configuration condition (step 154). The printer interface 50 then conveys a command to the printer 52 causing the printer to print an “Incompatible Configuration” message (step 156). The printer interface 50 also flashes the light emitting diode 68a in a fixed pattern unique to the non-compatible printer configuration condition and sounds the beeper 68b intermittently so that the non-compatible printer configuration condition can be readily detected (steps 158 and 160).

If the result of the comparison is positive at step 152, the printer interface 50 is deemed to be fully compatible with the printer 52 and the printer interface compatibility determination procedure is terminated.

If during the printer interface compatibility determination procedure, the printer interface 50 is determined to be firmware incompatible with the printer, and the printer interface is storing updated printer firmware in the non-volatile memory 66, the printer interface may initiate a printer firmware update procedure to download the updated printer firmware to the printer in an attempt to correct the non-compatible firmware condition. Preferably, the printer firmware update is performed in the manner disclosed in Applicants' co-pending U.S. patent application entitled “Method Of Updating Printer Firmware And Printing Device Employing Method”, filed on even date herewith and assigned to the present assignee, the content of which is incorporated by reference.

The incompatibility indicating circuitry 68 need not include both the LED 68a and the beeper 68b. The circuitry 68 can include a single indicator or multiple indicators such as for example an LED array. Other types of indicators to signal the printer interface incompatibility conditions can of course also be used.

Although specific reference is made to a printer used in a POS station, those of skill in the art will appreciated that this is for ease of illustration. The printer interface incompatibility detecting method is suitable for use in a variety of environments and with virtually any type of printer designed to accommodate a printer interface such as for example dot matrix printers, thermal printers, ink jet printers, laser jet printers etc.

Although embodiments have been described, those of skill in the art will appreciate that the variations and modifications may be made without departing from the spirit and scope of the invention as defined by the appended claims.

What is claimed is:

1. A method of detecting printer interface and printer incompatibility comprising:
sending at least one query from the printer interface to the printer requesting information concerning the printer;
in response to the query, determining whether the printer interface is compatible with the printer; and
if the printer interface is not compatible with the printer, signaling a non-compatible printer interface condition.

2. The method of claim 1 wherein said at least one query comprises a request for printer hardware information from said printer, if the printer hardware information received from said printer indicates that the printer interface is not compatible with the printer hardware, said printer interface signaling an incompatible printer condition.

3. The method of claim 2 wherein signaling of said incompatible printer condition comprises at least one of illuminating a light source and sounding a sound emitting device.

4. The method of claim 3 wherein signaling of said incompatible printer condition comprises both illuminating a light source and sounding a sound emitting device.

5. The method of claim 3 wherein said light source is illuminated in a flashing pattern unique to said incompatible printer condition.

6. The method of claim 2 wherein signaling of said incompatible printer condition comprises commanding said printer to print a non-compatible printer message.

7. The method of claim 3 wherein signaling of said incompatible printer condition further comprises commanding said printer to print a non-compatible printer message.

8. The method of claim 1 wherein said at least one query comprises a request for printer firmware information from said printer, if the printer firmware information received from said printer indicates that the printer interface is not compatible with the printer firmware, said printer interface signaling an incompatible firmware condition.

9. The method of claim 8 wherein signaling of said incompatible firmware condition comprises at least one of illuminating a light source and sounding a sound emitting device.

10. The method of claim 9 wherein signaling of said incompatible firmware condition comprises both illuminating a light source and sounding a sound emitting device.

11. The method of claim 9 wherein said light source is illuminated in a flashing pattern unique to said incompatible firmware condition.

12. The method of claim 8 wherein signaling of said incompatible firmware condition comprises commanding said printer to print a non-compatible firmware message.

13. The method of claim 9 wherein signaling of said incompatible firmware condition further comprises commanding said printer to print a non-compatible firmware message.

14. The method of claim 1 wherein said at least one query comprises a request for printer configuration information from said printer, if the printer configuration information received from said printer indicates that the printer interface is not compatible with the printer configuration, said printer interface signaling an incompatible printer configuration condition.

15. The method of claim 14 wherein signaling of said incompatible printer configuration condition comprises at least one of illuminating a light source and sounding a sound emitting device.

16. The method of claim 15 wherein signaling of said incompatible printer configuration condition comprises both illuminating a light source and sounding a sound emitting device.

17. The method of claim 15 wherein said light source is illuminated in a flashing pattern unique to said incompatible printer configuration condition.

18. The method of claim 14 wherein signaling of said incompatible printer configuration condition comprises commanding said printer to print a non-compatible printer configuration message.

19. The method of claim 15 wherein signaling of said incompatible printer configuration condition further comprises commanding said printer to print a non-compatible printer configuration message.

20. The method of claim 1 further comprising:
prior to said sending said at least one query, attempting communications with said printer to detect hardware compatibility between said printer interface and said printer;
if said printer interface and printer are hardware compatible, sending said at least one query; and
if said printer interface and printer are not hardware compatible, skipping sending of said at least one query and signaling said non-compatible printer interface condition.

21. A method of detecting printer interface and printer incompatibility comprising:
automatically sending a request for printer hardware and firmware information to said printer upon initialization of the printer interface in said printer;
examining the printer hardware and firmware information received in response to said request to determine if the printer interface is compatible with said printer; and
generating output when said printer interface is not compatible with said printer.

22. The method of claim 21 wherein said printer hardware and firmware information includes printer model and firmware version information.

23. The method of claim 21 wherein during examining the received printer hardware and firmware information is compared to lists of printer hardware and firmware information stored in said printer interface to detect coincidence.

24. The method of claim 23 further comprising:
prior to said sending said request, attempting communications with said printer to detect hardware compatibility between said printer interface and said printer;
if said printer interface and printer are hardware compatible, sending said request; and
if said printer interface and printer are not hardware compatible, skipping sending of said request and generating said output.

25. A printing device comprising:
a printer having a processing unit, memory storing printer firmware executed by the processing unit and a printer control mechanism responsive to the processing unit and printing information on a medium; and
a printer interface coupled to the printer and including a processing unit and memory storing a printer interface compatibility determination procedure, said printer interface compatibility determination procedure being automatically executed when the printer interface is initialized to determine whether the printer interface is compatible with the printer, said processing unit generating output when said printer interface is not compatible with said printer.

26. A printing device according to claim 25 wherein said printer interface includes at least one of a visual indicator and a sound emitting device responsive to said output to identify a non-compatible printer interface condition.

27. A printing device according to claim 26 wherein said at least one visual indicator is illuminated in a pattern unique to the type of non-compatible condition of said printer interface.

28. A printing device according to claim 27 wherein said printer interface non-compatible condition is a result of at least one of a printer hardware, printer firmware and printer configuration incompatibility.
